(19) United States
(12) Patent Application Publication
(10) Pub. No.: US 2012/0085862 A1
(43) Pub. Date: Apr. 12, 2012

(54) AIRCRAFT GALLEY HAVING A PARTITION PANEL SYSTEM

(75) Inventor: Iwan Pangalila, Hamburg (DE)

(73) Assignee: AIRBUS OPERATIONS GMBH, Hamburg (DE)

(21) Appl. No.: 13/145,133

(22) PCT Filed: Jan. 21, 2010
(86) PCT No.: PCT/EP2010/000352

§ 371 Date: Dec. 8, 2011

Related U.S. Application Data
(60) Provisional application No. 61/146,210, filed on Jan. 21, 2009.

(30) Foreign Application Priority Data
Jan. 21, 2009 (DE) 102009005478.2

(51) Int. Cl. B64D 11/04; B23P 17/04

(52) U.S. Cl. 244/118.5; 29/428

(57) ABSTRACT

An aircraft galley partition panel system has first and second partition panels. An assembly slot extends from an edge of the first panel and receives an assembly section of the second panel such that main surfaces of the first and second panels are substantially perpendicular. A first guide device carried by the assembly slot interacts with a complementary second guide device arranged in a region of the assembly section of the second panel. An assembly section of the first partition panel carries a third guide device which interacts with a complementary fourth guide device arranged in a region of a lateral surface of the second panel facing the assembly section of the first panel. Projections of the first and second connecting devices are received in complementary recesses in a base body of the aircraft galley to connect the first and second panels respectively to the base body.

### CROSS-REFERENCE TO RELATED APPLICATIONS

This application is the U.S. national phase of PCT/EP2010/000352 filed Jan. 21, 2010. PCT/EP2010/000352 claims the benefit under the Convention of German Patent Application No. 102009005478.2 and U.S. Provisional Patent Application No. 61/146,210 both filed on Jan. 21, 2009.

### FIELD OF INVENTION

The present invention relates to an aircraft galley having a partition panel system for dividing a base body of the aircraft galley into a plurality of compartments. The invention further relates to a method for assembly of such an aircraft galley.

### BACKGROUND OF THE INVENTION

An aircraft galley of modular construction comprising a base body divided into a plurality of compartments is known from WO 2007/096000 A1. Various appliances, such as, for example, an oven or a microwave appliance, are arranged in the compartments of the base body. Furthermore, the compartments of the base body receive boxes, in which service products, such as, for example, food or drinks, for supplying to the passengers on board the aircraft can be accommodated.

### SUMMARY

The object on which the invention is based is to provide an aircraft galley having a base body which is divided into a plurality of compartments by means of a lightweight and easily assemblable partition panel system. Furthermore, an object on which the invention is based is to specify a method for assembly of such an aircraft galley.

This object is achieved by an aircraft galley having the features of claim 1 and a method for assembly of an aircraft galley having the features of claim 13.

An aircraft galley according to the invention comprises a base body which is divided into a plurality of compartments by a partition panel system. The base body of the aircraft galley can be configured, for example, in the form of a right parallelepiped. The partition panel system comprises a first partition panel and a second partition panel. In the first partition panel there is formed at least one assembly slot which extends from a first edge of the first partition panel in the direction of an inner region of the first partition panel. The assembly slot formed in the first partition panel receives an assembly section of the second partition panel. The shape and width of the assembly slot formed in the first partition panel is preferably adapted to the thickness of the second partition panel in the region of its assembly section.

The assembly slot formed in the first partition panel and the assembly section of the second partition panel are designed such that main surfaces of the first partition panel are oriented substantially perpendicularly to main surfaces of the second partition panel.

The assembly slot formed in the first partition panel is preferably bounded by two lateral surfaces which extend substantially perpendicularly to the main surfaces of the first partition panel. At least one of the lateral surfaces of the assembly slot formed in the first partition panel carries a first guide device. The first guide device interacts with a complementary second guide device arranged in the region of the assembly section of the second partition panel. By the interaction of the first guide device with the second guide device, the first and the second partition panel are securely connected to one another in the region of the assembly slot formed in the first partition panel and in the region of the assembly section of the second partition panel, respectively.

In the case of the aircraft galley according to the invention, the first partition panel of the partition panel system further likewise comprises an assembly section which extends from an end face of the assembly slot formed in the first partition panel in the direction of a second edge of the first partition panel opposite the first edge of the first partition panel. The assembly section of the first partition panel carries a third guide device which interacts with a complementary fourth guide device. The fourth guide device is arranged in the region of a lateral surface of the second partition panel facing the assembly section of the first partition panel. In other words, in the case of the aircraft galley according to the invention, the first and the second partition panel are also securely connected to one another in the region of the assembly section of the first partition panel and in the region of the lateral surface of the second partition panel facing the assembly section of the first partition panel, respectively.

In the case of the aircraft galley according to the invention, the design of the partition panels and of the guide devices used to connect the partition panels enables an optimised force transmission between the partition panels. The partition panels can therefore be designed with a comparatively low thickness and thus a comparatively light weight. Furthermore, the guide devices facilitate the assembly of the partition panel system and thus the aircraft galley as a whole.

A particularly secure connection of the partition panels and a particularly easy assembly of the aircraft galley according to the invention is possible when the first and/or the second guide device extend(s) substantially over the entire length of the assembly slot of the first partition panel and/or the entire length of the assembly section of the second partition panel received in the assembly slot of the first partition panel. Similarly, the third and/or the fourth guide device preferably extend(s) over the entire length of the assembly section of the first partition panel and the lateral surface of the second partition panel facing the assembly section of the first partition panel, respectively.

The first and the second partition panel can form a substantially T-shaped structure. The assembly section of the second partition panel is then preferably formed by a projection which extends adjacently to the lateral surface of the second partition panel facing the assembly section of the first partition panel into the assembly slot formed in the first partition panel.

However, there can likewise be formed in the second partition panel at least one assembly slot which extends from a first edge of the second partition panel in the direction of an inner region of the second partition panel. In the case of such an arrangement, the lateral surface of the second partition panel facing the assembly section of the first partition panel is formed by a first lateral surface of the assembly slot formed in the second partition panel. The assembly section of the second partition panel then extends from an end face of the assembly slot formed in the second partition panel in the direction of a second edge of the second partition panel opposite the first edge of the second partition panel. With a partition panel system which comprises two partition panels provided with an assembly slot, a cross-shaped partition panel arrangement, for example, can be realised.

To improve the connection of the first partition panel to the second partition panel, preferably both the first lateral surface of the assembly slot formed in the first partition panel and a second lateral surface of the assembly slot formed in the first partition panel opposite the first lateral surface carries a first guide device. The two mutually opposite first guide devices preferably interact with complementary second guide devices which are arranged in the region of the assembly section of the second partition panel in the region of a first main surface and of a second main surface of the second of the second partition panel opposite the first main surface. If not only the first partition panel, but also the second partition panel of the partition panel system is provided with an assembly slot, the assembly section of the first partition panel preferably further carries two third guide devices which are arranged in the region of the assembly section of the first partition panel in the region of a first main surface and of a second main surface of the first partition panel opposite the first main surface. The third guide devices preferably interact with two fourth guide devices which are carried by the first lateral surface of the assembly slot formed in the second partition panel and a second lateral surface of the assembly slot formed in the second partition panel opposite the first lateral surface.

The assembly slot formed in the first partition panel preferably extends substantially perpendicularly from the first edge of the first partition panel in the direction of an inner region of the first partition panel. Additionally or alternatively to this, the assembly slot formed in the second partition panel can extend substantially perpendicularly from the first edge of the second partition panel in the direction of the inner region of the first partition panel. As a result, the partition panels of the partition panel system can define cube-shaped or right-parallelepiped-shaped compartments in the base body of the aircraft galley.

In a preferred embodiment of the aircraft galley according to the invention, the assembly slot formed in the first partition panel extends from the first edge of the first partition panel up to a centre axis of the first partition panel. Alternatively or additionally to this, the assembly slot formed in the second partition panel can extend from the first edge of the second partition panel up to a centre axis of the second partition panel. Such a configuration of the partition panels enables a particularly secure connection of the partition panels, without a configuration of the partition panels with assembly slots which are too long resulting in undesired impairment of the mechanical properties, i.e. the load-bearing capacity of the partition panels.

An optimal connection of the partition panels of the partition panel system is possible when the first and the second guide device and/or the third and the fourth guide device each form a dovetail joint. To realise a dovetail joint, the first guide device can comprise, for example, a rail which is suitable for receiving a dovetail projection of the second guide device. Of course, it is however also conceivable for the first guide device to be provided with a dovetail projection which is received in a suitable rail of the second guide device. Similarly, to realise a dovetail joint, the third guide device can have a dovetail projection which is received in a correspondingly shaped rail of the fourth guide device. Finally, the fourth guide device can comprise a dovetail projection which is received in a correspondingly shaped rail of the third guide device.

A plurality of assembly slots can be formed in the first and/or in the second partition panel. As a result, the number of partition panels which have to be used in an aircraft galley according to the invention in order to divide the base body of the aircraft galley into individual compartments can be advantageously reduced.

The first and/or the second partition panel can have a substantially rectangular basic shape. There can be provided in the region of at least one edge of the first partition panel a first connecting device for connecting the first partition panel to the base body of the aircraft galley. Similarly, there can be provided in the region of at least one edge of the second partition panel a second connecting device for connecting the second partition panel to the base body of the aircraft galley.

For example, the first connecting device of the first partition panel comprises at least one projection which is received in a complementary recess formed in the aircraft galley base body, for example in a side wall or a rear wall of the base body. Alternatively to this, the first connecting device of the first partition panel can also comprise a recess which receives a projection formed on the base body of the aircraft galley. Similarly, the second connecting device of the second partition panel can comprise at least one projection which is received in a complementary recess formed in the aircraft galley base body, for example a top panel or a rear wall of the aircraft galley base body. Alternatively to this, however, the second connecting device can also comprise a recess which receives a projection formed on the base body of the aircraft galley. Such a configuration of the partition panels of the partition system enables, in a first step, the assembly of the partition panel system before, in a second assembly step, individual components of the base body, such as, for example, side walls and/or a top panel of the base body, can be connected to the partition panels of the partition system.

The first and/or the second partition panel preferably contain(s) a fibre-reinforced material, such as, for example, a fibre-reinforced polyetherimide (PEI) material. Furthermore, the partition panels can also consist of a sandwich material which comprises, for example, a core with a honeycomb structure or a foamed core. The sandwich material can contain a phenolic resin material and/or covering layers consisting of aramid paper, for example, can adjoin the core. The reinforcing fibres can be, for example, carbon fibres or glass fibres.

Reinforcing fibres contained in the material of the first and/or the second partition panel are preferably oriented substantially parallel to the assembly slot formed in the first and/or the second partition panel. In other words, the reinforcing fibres contained the material of the first and/or the second partition panel have a preferred orientation substantially parallel to the assembly slot formed in the first and/or the second partition panel. Preferably, at least 80% of the reinforcing fibres are oriented in this preferred direction. The mechanical properties of the partition panels are improved by such an orientation of the reinforcing fibres.

The first and the second partition panel are preferably designed such that they define a plurality of equal-size compartments in the base body of the aircraft galley. The partition panel system of the galley according to the invention can, as required, comprise a plurality of first and/or a plurality of second partition panels which can each be designed such that they define a plurality of equal-size compartments in the base body of the aircraft galley. As a result, a modular basic construction of the aircraft galley according to the invention can be realised in a simple manner. At the same time, partition panels arranged at equal spacings from one another enable an optimised load transmission between the partition panels, so that the partition panels can be designed thinner or thus lighter in weight for the same load-bearing capacity.

In a method for assembly of an aircraft galley according to the invention, in a first step, a first partition panel and a second partition panel are provided, there being formed in the first partition panel at least one assembly slot which extends from a first edge of the first partition panel in the direction of an inner region of the first partition panel. The first partition panel is connected to the second partition panel in such a manner that the assembly slot formed in the first partition panel receives an assembly section of the second partition panel, the assembly slot formed in the first partition panel and the assembly section of the second partition panel being designed such that main surfaces of the first partition panel are oriented substantially perpendicularly to main surfaces of the second partition panel. A first guide device carried by at least one lateral surface of the assembly slot formed in the first partition panel interacts with a complementary second guide device arranged in the region of the assembly section of the second partition panel. Furthermore, a third guide device carried by an assembly section of the first partition panel, which extends from an end face of the assembly slot formed in the first partition panel in the direction of a second edge of the first partition panel opposite the first edge of the first partition panel, interacts with a complementary fourth guide device. The fourth guide device is arranged in the region of a lateral surface of the second partition panel facing the assembly section of the first partition panel.

Preferably, the first partition panel is connected to the second partition panel in such a manner that an assembly slot formed in the second partition panel and extending from a first edge of the second partition panel in the direction of an inner region of the second partition panel receives the assembly section of the first partition panel.

In a preferred embodiment of the method according to the invention, firstly the partition panels are connected to one another. Subsequently, components of a base body of the aircraft galley, for example side walls and a rear wall of the aircraft galley base body, are connected to the first partition panel by means of a first connecting device provided in the region of at least one edge of the first partition panel. Furthermore, further components of the aircraft galley base body, for example a top panel and the rear wall, can be connected to the second partition panel by means of a second connecting device provided in the region of at least one edge of the second partition panel.

### BRIEF DESCRIPTION OF THE DRAWINGS

A preferred embodiment of the invention will now be explained in more detail with reference to the appended schematic drawings, of which

FIG. 1 shows a schematic cross-sectional view of an aircraft galley,

FIG. 2 shows the connection of a first and a second partition panel of a partition panel system of the aircraft galley according to FIG. 1,

FIG. 3 shows the partition panel system illustrated in FIG. 2 in a connected state,

FIG. 4 shows a detail cross-sectional view of the partition panel system according to FIG. 3 in the region of an assembly slot formed in the first partition panel,

FIG. 5 shows a detail cross-sectional view of the partition panel system according to FIG. 3 in the region of an assembly section of the first partition panel,

FIG. 6 shows the assembly of a further partition panel system having two first and two second partition panels,

FIG. 7 shows a detail cross-sectional view of the partition panel system according to FIG. 6 in the region of an assembly slot formed in the first partition panel,

FIG. 8 shows a detail cross-sectional view of the partition panel system according to FIG. 6 in the region of an assembly section of the first partition panel,

FIG. 9 shows a detail cross-sectional view of an alternative partition panel system in the region of an assembly slot formed in a first partition panel, and

FIG. 10 shows a detail cross-sectional view of the partition panel system according to FIG. 9 in the region of an assembly section of the first partition panel.

### DETAILED DESCRIPTION

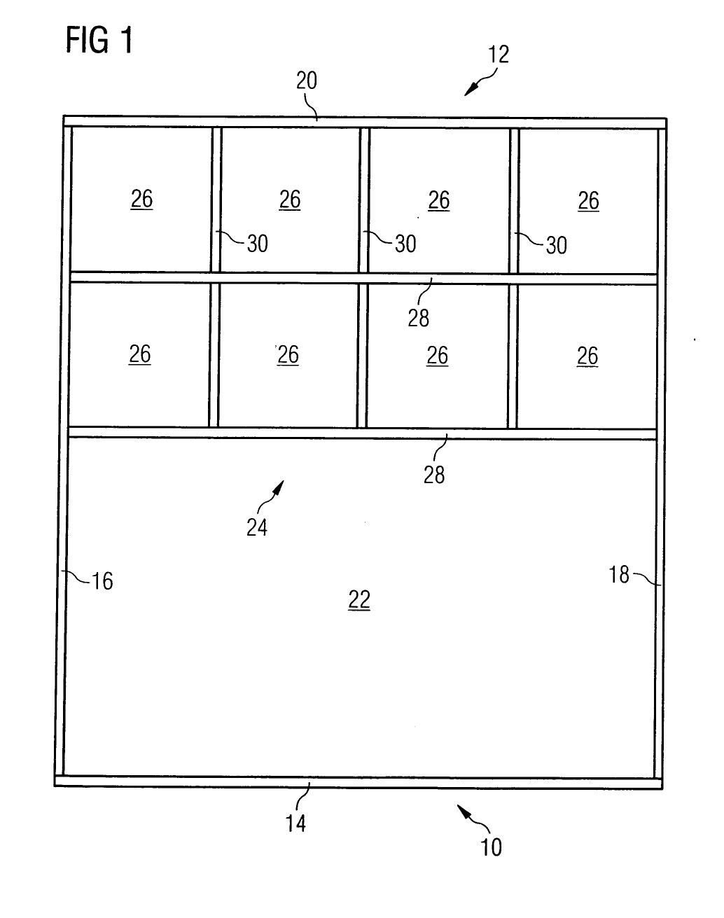

FIG. 1 shows an aircraft galley 10 having a base body 12. The aircraft galley base body 12 comprises a bottom panel 14, two mutually opposite side walls 16, 18, a top panel 20 and a rear wall 22. A partition panel system 24 divides an upper region of the aircraft galley base body 12 into a plurality of equal-size compartments 26.

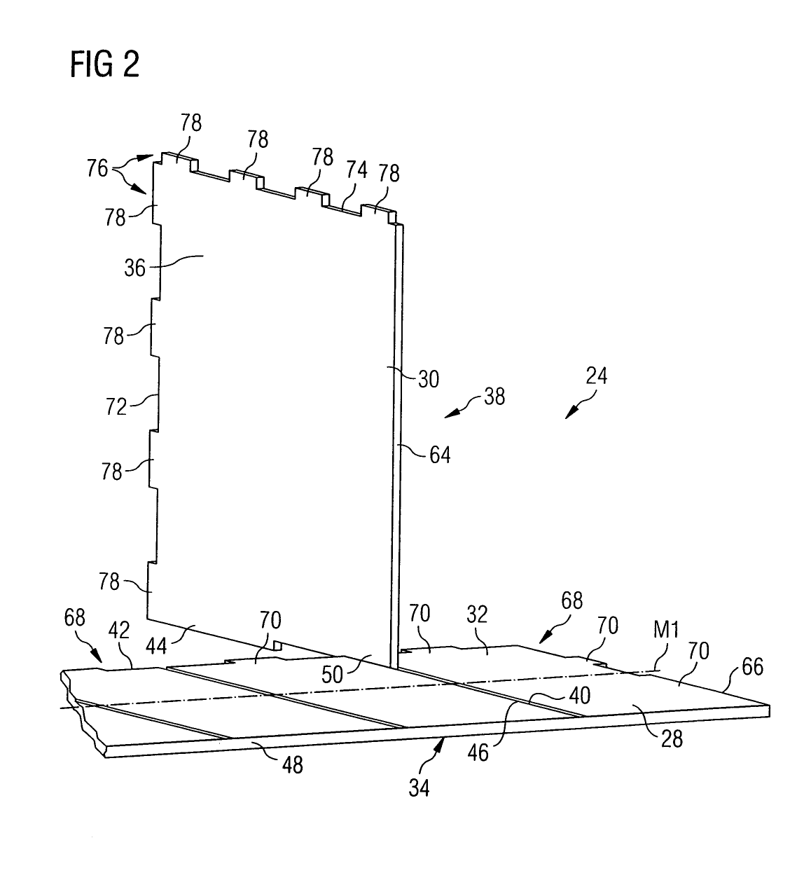

A first embodiment of a partition panel system 24 used in the aircraft galley 10 according to FIG. 1 is illustrated in FIGS. 2 to 5. The partition panel system 24 comprises a horizontally arranged first partition panel 28 and a substantially vertically arranged second partition panel 30. Main surfaces 32, 34 of the first partition panel 28 are thus oriented substantially perpendicularly to main surfaces 36, 38 of the second partition panel 30. In the first partition panel 28 there are formed a plurality of assembly slots 40 which extend substantially parallel to one another from a first edge 42 of the first partition panel 40 in the direction of an inner region of the first partition panel 40 up to a centre axis M1 of the partition panel. The assembly slots 40 are oriented substantially perpendicularly to the first edge 42 of the first partition panel 28. Each of the assembly slots 40 formed in the first partition panel 28 serves to receive an assembly section 44 which is formed on a corresponding second partition panel 30. The width of the assembly slots formed in the first partition panel 28 is therefore adapted to the thickness of the assembly section 44 formed on each second partition panel 30.

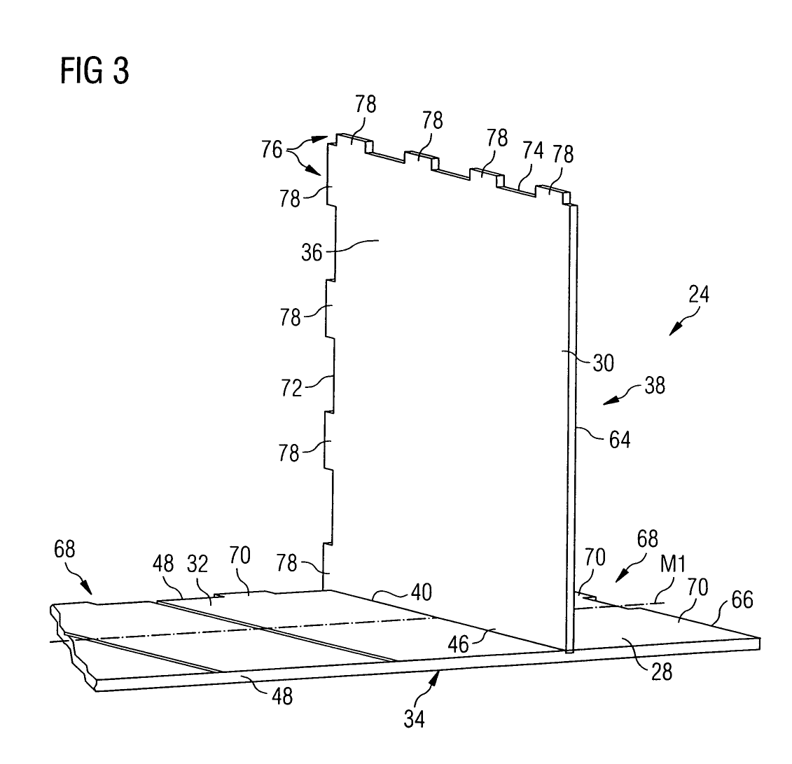

The first partition panel 28 further comprises an assembly section 46 which extends from an end face, i.e. a closed end, of the assembly slot 40 formed in the first partition panel 28 in the direction of a lateral edge 48 of the first partition panel 28 opposite the first edge 42 of the first partition panel 28. In a connected state of the partition panel system 24 illustrated in FIG. 3, the assembly section 46 of the first partition panel 28 interacts with a lateral surface 50 of the second partition panel 30 facing the assembly section 46 of the first partition panel 28. The assembly section 44 of the second partition panel 30 is formed by a projection which extends adjacently to the lateral surface 50 of the second partition panel 30 which faces the assembly section 46 of the first partition panel 28 in the assembled state of the partition panel system 24 illustrated in FIG. 3, i.e. interacts with the assembly section 46 of the first partition panel 28.

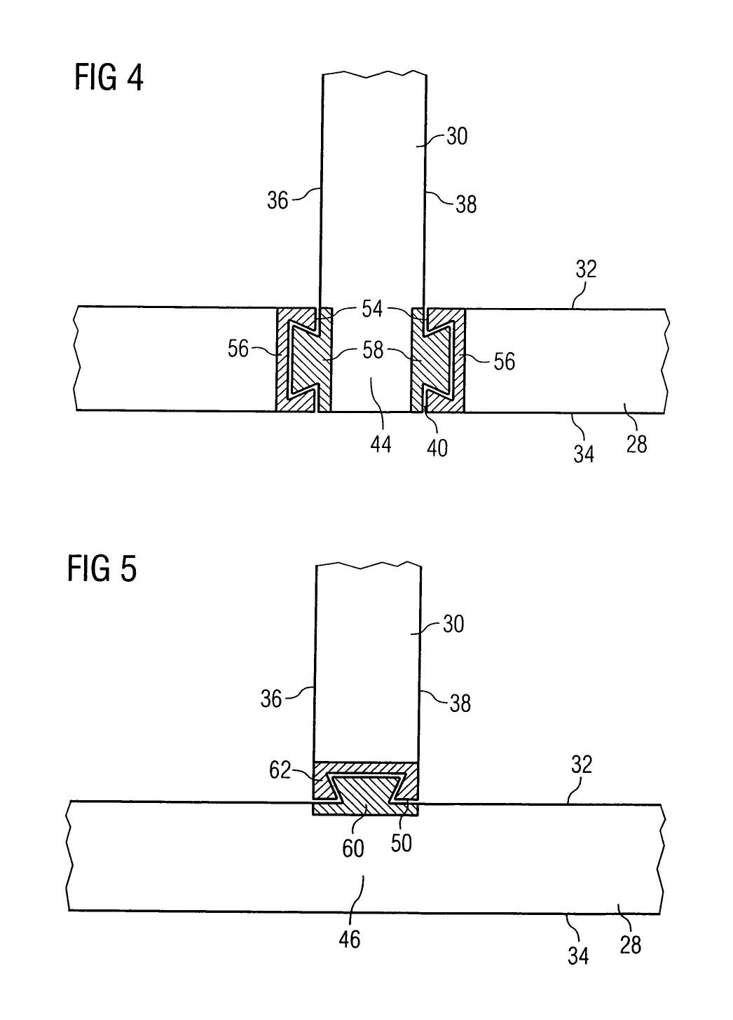

As can be seen in FIG. 4, the assembly slot 40 formed in the first partition panel 28 is bounded by lateral surfaces 52, 54 which extend substantially parallel to one another and perpendicularly to the main surfaces 32, 34 of the first partition panel 28. The lateral surfaces 52, 54 of the assembly slot 40 each carry a first guide device 56 configured in the form of a rail. Each of the first guide devices 56 configured in the form of a rail receives a second guide device 58 configured in the form of a dovetail projection which extends in the region of the assembly section 44 of the second partition panel 30 from one of the main surfaces 36, 38 of the second partition panel 30.

FIG. 5 finally illustrates the configuration of the connection between the first partition panel 28 and the second partition panel 30 in the region of the assembly section 46 of the first partition panel 28 and of the lateral surface 50 of the second partition panel 30. The assembly section 46 of the first partition panel 28 carries a third guide device 60 configured in the form of a dovetail projection. The third guide device 60 configured in the form of a dovetail projection is received in a complementary fourth guide device 62 configured in the form of a rail which is arranged in the region of the lateral surface 50 of the second partition panel 30. The third and the fourth guide device 60, 62, as well as the first and the second guide device 56, 58, thus form a dovetail joint. In order to ensure an optimal connection of the partition panels 28, 30 of the partition panel system 24, the first guide device 56 and the second guide device 58 extend along the entire length of the assembly slot 40 formed in the first partition panel 28 and over the entire length of the assembly section 44 of the second partition panel 30, respectively. Likewise, the third and the fourth guide device 60, 62 extend over the entire length of the assembly section 46 of the first partition panel 28 and over the entire length of the lateral surface 50 of the second partition panel 30, respectively.

In the arrangement illustrated in FIGS. 4 and 5, the first guide device 56, the second guide device 58, the third guide device 60 and the fourth guide device 62 are designed in the form of separate components which are fastened to the first partition panel 28 and the second partition panel 30, respectively. Alternatively to this, however, all of the guide devices 56, 58, 60, 62 or some of the guide devices 56, 58, 60, 62 can also be formed integrally with the first partition panel 28 and the second partition panel 30, respectively. Furthermore, it is conceivable to provide a first guide device in the form of a dovetail projection and a second guide device in the form of a rail. Similarly, the third guide device can be designed in the form of a rail and the fourth guide device in the form of a dovetail projection.

As is best illustrated by FIGS. 2 and 3, the second partition panel 30 is connected to the first panel 28 by displacing the second partition panel 30 in such a manner relative to the first partition panel 28 that the assembly slot 40 formed in the first partition panel 28 receives the assembly section 44 of the second partition panel 30. From the position illustrated in FIG. 2, in which a first edge 64 of the second partition panel 30 is aligned with an end face, i.e. a closed end, of the assembly slot 40 formed in the first partition panel 28, the displacement of the second partition panel 30 relative to the first partition panel 28 is guided by the interaction of the first guide device 56 with the second guide device 58 and the interaction of the third guide device 60 with the fourth guide device 62.

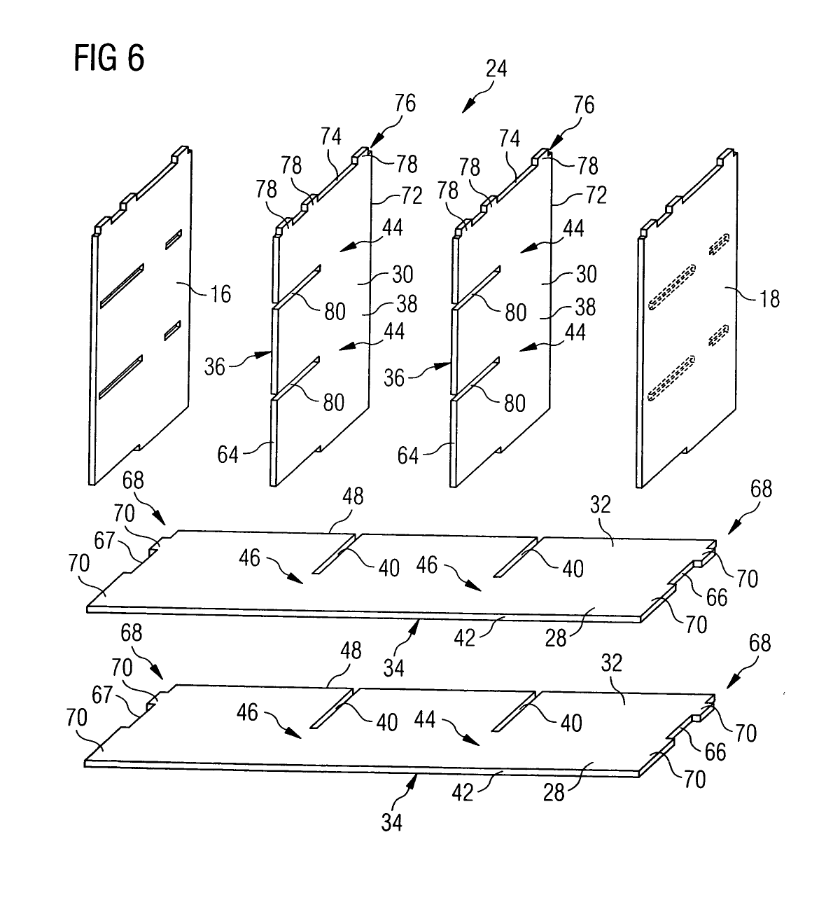

In the region of a third edge 66 of the first partition panel 28, as well as in the region of a fourth edge 67 of the first partition panel 28, not shown in FIGS. 2 and 3 but illustrated in FIG. 6, there is provided a first connecting device 68 which comprises a plurality of projections 70. Similarly, the second edge 48 of the first partition panel 28 carries a first connecting device 68 having a plurality of projections 70. The projections 70 of the first connecting device 68 are provided for reception in complementary recesses which are formed in the side walls 16, 18 and in the rear wall 22 of the aircraft galley base body 12.

Similarly, in the region of a second edge 72 and of a third edge 74 of the second partition panel 30, there is in each case provided a second connecting device 76. The second connecting device 76 comprises a plurality of projections 78. The projections 78 of the second connecting device 76 arranged in the region of the second edge 72 of the second partition panel 30 are provided for reception in complementary recesses which are formed in the rear wall 22 of the aircraft galley base body 12. By contrast, the projections 78 of the second connecting device 76 arranged in the region of the third edge 74 of the second partition panel 30 are provided for reception in complementary recesses which are provided in the top panel 20 of the aircraft galley base body 12. During the assembly of the aircraft galley 10, firstly the partition panels 28, 30 of the partition panel system 24 can thus be connected to one another as described. Subsequently, the side walls 16, 18 and also the top panel 20 and the rear wall 22 of the aircraft galley base body 12 can be connected to the partition panels 28, 30 of the partition panel system 24.

In order to be able to provide the aircraft galley 10 with partition panels 28, 30 which can be highly loaded but nevertheless are designed as thin as possible, the first partition panel 28 and the second partition panel 30 of the partition panel system 24 contain a fibre-reinforced material. For example, a material provided with a core in the form of a honeycomb structure or a foam core can be used. Reinforcing fibres contained in the material of the first and the second partition panel 28, 30 of the partition panel system 24 have a preferred orientation. The reinforcing fibres contained in the first partition panel 28 are oriented substantially parallel to the assembly slot 40 formed in the first partition panel 28. By contrast, the reinforcing fibres contained in the second partition panel 30 extend substantially in a direction perpendicular to the first and the second edge 64, 72 of the second partition panel 30.

An alternative embodiment of a partition panel system 24 comprising two first partition panels 28 and two second partition panels 30 is illustrated in FIGS. 6 to 10. The second partition panels 30 of the partition panel system 24, as well as the first partition panels 28, are provided with a plurality of assembly slots 80. The assembly slots 80 of the second partition panels 30 extend parallel to one another and perpendicularly to the first edge 64 of the second partition panels 30 in the direction of an inner region of the second partition panels 30 up to a centre axis M2 of the second partition panels 30. When a first partition panel 28 and a second partition panel 30 of the partition panel system 24 illustrated in FIGS. 6 to 10 are connected to one another, the assembly section 46 of the first partition panel 28 is received in an assembly slot 80 formed in the second partition panel 30. In other words, lateral surfaces 82, 84 of the assembly slot 80 formed in the second partition panel 30 which are arranged substantially parallel to one another and substantially perpendicularly to the main surfaces 36, 38 of the second partition panel 30 interact with the assembly section 46 of the first partition panel 28.

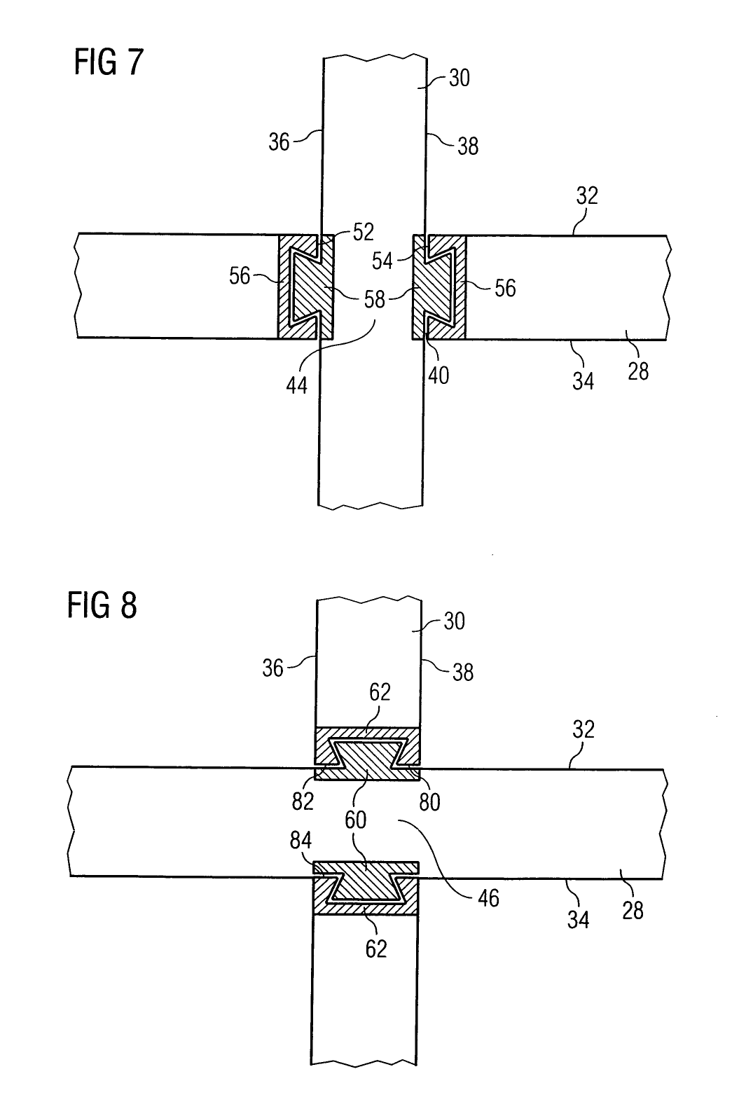

In an arrangement similar to that illustrated in FIGS. 2 to 5, the lateral surfaces 52, 54 of the assembly slot 40 formed in the first partition panel 28 each carry a guide device 56 configured in the form of rail. A complementary second guide device 58 is received in each of the correspondingly shaped first guide devices 56 in the form of rails. The second guide devices 58 are each configured in the form of a dovetail projection and extend in the region of the assembly section 44 of the second partition panel 30 from the mutually opposite main surfaces 36, 38 of the second partition panel 30 (see FIG. 7).

The first partition panel 28 is provided with two third guide devices 60 in the region of its assembly section 46. The third guide devices 60 are configured in the form a dovetail projection and extend in the region of the assembly section 46 of the first partition panel 28 from the mutually opposite main surfaces 32, 34 of the first partition panel 28. Each of the third guide devices 60 is received in a complementary fourth guide device 62. The fourth guide devices 62 are each configured in the form of a rail and are arranged in the region of the lateral surfaces 82, 84 of the assembly slot 80 formed in the second partition panel 30. In order to enable an optimal connection of the partition panels 28, 30 of the partition panel system 24, the first guide device 56 and the second guide device 58 extend over the entire length of the assembly slot 40 formed in the first partition panel 28 and over the entire length of the assembly section 44 of the second partition panel 30, respectively. Similarly, the third guide device 60 and the fourth guide device 62 extend over the entire length of the assembly section 46 of the first partition panel 28 and over the entire length of the assembly slot 80 formed in the second partition panel 30, respectively.

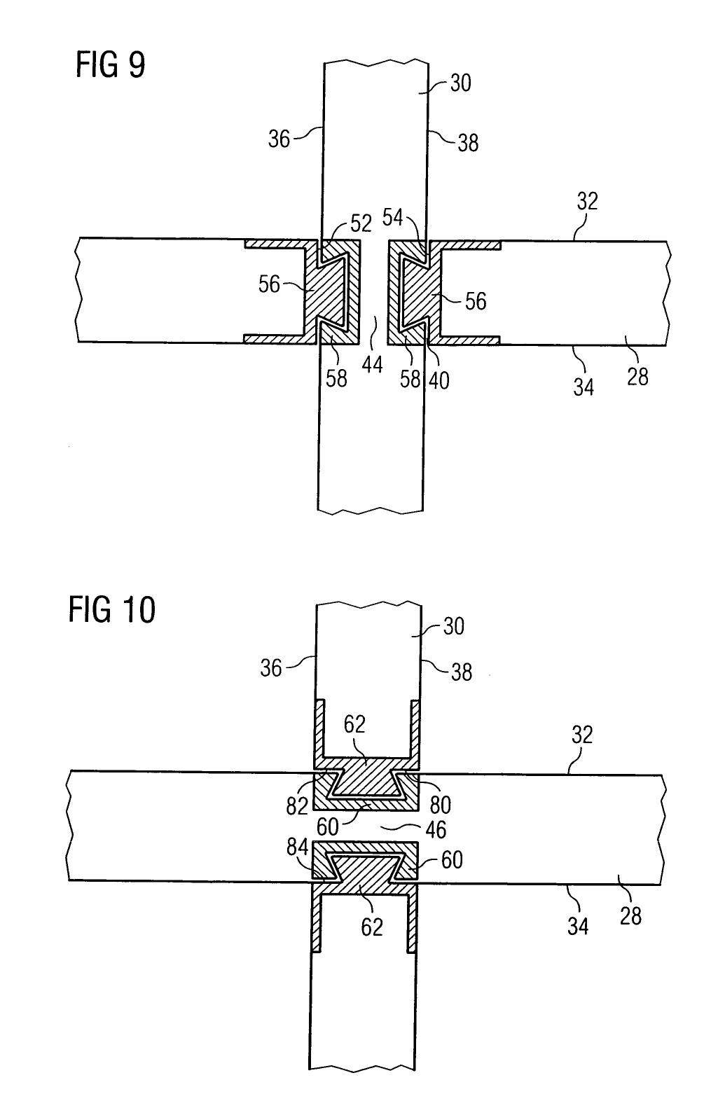

FIGS. 9 and 10 show an alternative embodiment of the guide devices 56, 58, 60, 62 of the partition panel system according to FIG. 6. In particular, FIG. 9 shows an arrangement in which first guide devices 56 are configured in the form of a dovetail projection and complementary second guide devices 58 are configured in the form of a rail. Finally, FIG. 10 illustrates third guide devices 60 configured in the form of a rail which receive complementary fourth guide devices 62 each configured in the form of a dovetail projection.

In other respects, the construction and assembly of the partition panel system 24 according to FIGS. 6 to 10 corresponds to the construction and assembly of the system shown in FIGS. 2 to 5. Furthermore, it will be understood that the arrangement according to FIGS. 2 to 5 can be combined in any desired manner with the arrangement shown in FIGS. 6 to 10 in a single partition panel system.

1-15. (canceled)

16. An aircraft galley having a base body which is divided into a plurality of compartments by a partition panel system, the partition panel system comprising:
a first partition panel and
a second partition panel, characterised in that there is formed in the first partition panel at least one assembly slot which extends from a first one of a plurality of edges of the first partition panel in the direction of an inner region of the first partition panel and which receives an assembly section of the second partition panel, the at least one assembly slot formed in the first partition panel and the assembly section of the second partition panel being designed such that main surfaces of the first partition panel are oriented substantially perpendicularly to main surfaces of the second partition panel, at least one lateral surface of the at least one assembly slot formed in the first partition panel carrying a first guide device which interacts with a complementary second guide device arranged in a region of the assembly section of the second partition panel, an assembly section of the first partition panel, which extends from an end face of the at least one assembly slot formed in the first partition panel in the direction of a second one of the plurality of edges of the first partition panel opposite the first one of the plurality of edges of the first partition panel, carrying a third guide device which interacts with a complementary fourth guide device arranged in a region of a lateral surface of the second partition panel facing the assembly section of the first partition panel, there being provided in a region of at least one of the plurality of edges of the first partition panel a first connecting device for connecting the first partition panel to the base body of the aircraft galley and there being provided in a region of at least one of the plurality of edges of the second partition panel a second connecting device for connecting the second partition panel to the base body of the aircraft galley, the first connecting device and the second connecting device comprising a plurality of projections which are received in complementary recesses in the base body of the aircraft galley.

17. An aircraft galley according to claim 16, characterised in that the assembly section of the second partition panel is formed by a projection which extends adjacently to the lateral surface of the second partition panel facing the assembly section of the first partition panel into the at least one assembly slot formed in the first partition panel.

18. An aircraft galley according to claim 16, characterised in that there is formed in the second partition panel at least one assembly slot which extends from a first one of a plurality of edges of the second partition panel in the direction of an inner region of the second partition panel, such that the lateral surface of the second partition panel facing the assembly section of the first partition panel is formed by a first lateral surface of the at least one assembly slot formed in the second partition panel and the assembly section of the second partition panel extends from an end face of the at least one assembly slot formed in the second partition panel in the direction of a second one of the plurality of edges of the second partition panel opposite the first one of the plurality of edges of the second partition panel.

19. An aircraft galley according to claim 16, characterised in that at least one of the at least one assembly slot formed in the first partition panel extends substantially perpendicularly from the first one of the plurality of edges of the first partition panel in the direction of the inner region of the first partition panel and the at least one assembly slot formed in the second partition panel extends substantially perpendicularly from the first one of the plurality of edges of the second partition panel in the direction of the inner region of the first partition panel.

20. An aircraft galley according to claim 16, characterised in that at least one of the at least one assembly slot formed in the first partition panel extends from the first one of the plurality of edges of the first partition panel up to a centre axis of the first partition panel and the at least one assembly slot formed in the second partition panel extends from the first one of the plurality of edges of the second partition panel up to a centre axis of the second partition panel.

21. An aircraft galley according to claim 16, characterised in that at least one of the first guide device and the second guide device form a dovetail joint and the third guide device and the fourth guide device form a dovetail joint.

22. An aircraft galley according to claim 16, characterised in that a plurality of assembly slots are formed in at least one of the first partition panel and the second partition panel.

23. An aircraft galley according to claim 16, characterised in that at least one of the first partition panel and the second partition panel contains a fibre-reinforced material.

24. An aircraft galley according to claim 23, characterised in that at least one of the fibre-reinforced material of the first partition panel contains reinforcing fibres oriented substantially parallel to the at least one assembly slot formed in the first partition panel and the fibre-reinforced material of the second partition panel contains reinforcing fibres oriented substantially parallel to at least one assembly slot formed in the second partition panel.

25. An aircraft galley according to claim 16, characterised in that the first and the second partition panel are designed such that they define a plurality of equal-size compartments in the base body of the aircraft galley.

26. A method for assembly of an aircraft galley having a first partition panel and a second partition panel, characterised in that there is formed in the first partition panel at least one assembly slot which extends from a first one of a plurality of edges of the first partition panel in the direction of an inner region of the first partition panel, the method comprising:
connecting the first partition panel to the second partition panel in such a manner that the at least one assembly slot formed in the first partition panel receives an assembly section of the second partition panel, the at least one assembly slot formed in the first partition panel and the assembly section of the second partition panel being designed such that main surfaces of the first partition panel are aligned substantially perpendicularly to main surfaces of the second partition panel, a first guide device carried by at least one lateral surface of the at least one assembly slot formed in the first partition panel interacts with a complementary second guide device arranged in a region of the assembly section of the second partition panel, a third guide device carried by an assembly section of the first partition panel, which extends from an end face of the at least one assembly slot formed in the first partition panel in the direction of a second one of the plurality of edges of the first partition panel opposite the first one of the plurality of edges of the first partition panel, interacts with a complementary fourth guide device arranged in a region of a lateral surface of the second partition panel facing the assembly section of the first partition panel, and
connecting at least one of the first partition panel and the second partition panel to components of a base body of the aircraft galley by at least one of a first connecting device provided in a region of at least one of the plurality of edges of the first partition panel and a second connecting device provided in a region of at least one of the plurality of edges of the second partition panel.

27. A method according to claim 26, characterised in that connecting the first partition panel to the second partition panel comprises connecting the first partition panel to the second partition panel in such a manner that an assembly slot formed in the second partition panel and extending from a first one of the plurality of edges of the second partition panel in the direction of an inner region of the second partition panel receives the assembly section of the first partition panel.
